(19) United States
(12) Patent Application Publication
(10) Pub. No.: US 2022/0036230 A1
(43) Pub. Date: Feb. 3, 2022

(54) QUANTUM ENTANGLED STATE PROCESSING METHOD, DEVICE, AND STORAGE MEDIUM

(71) Applicant: BEIJING BAIDU NETCOM SCIENCE TECHNOLOGY CO., LTD., Beijing (CN)

(72) Inventors: Xin WANG, Beijing (CN); Xuanqiang Zhao, Beijing (CN); Benchi Zhao, Beijing (CN); Zihe Wang, Beijing (CN); Zhixin Song, Beijing (CN); Renyu Liu, Beijing (CN)

(21) Appl. No.: 17/501,755

(22) Filed: Oct. 14, 2021

(30) Foreign Application Priority Data
Dec. 23, 2020 (CN) 202011541542.1

(51) Int. Cl. G06N 10/00

(52) U.S. Cl. CPC G06N 10/00

(57) ABSTRACT

A quantum entangled state processing method, a device, and a storage medium are provided, which are related to a field of quantum calculation. The specific implementation scheme includes: determining n initial quantum states to be processed; determining at least two nodes associated with the initial quantum state; acquiring at least one first parameterized quantum circuit required by the first node and at least one second parameterized quantum circuit required by the second node matched with a preset processing scenario; controlling, based on an initial quantum operation strategy, the first node to perform a local quantum operation to obtain a first measurement result, controlling the second node to perform a local quantum operation to obtain a second measurement result; obtaining an output quantum state meeting a preset requirement of the preset processing scenario at least based on the first measurement result and the second measurement result.

### CROSS-REFERENCE TO RELATED APPLICATIONS

This application claims priority to Chinese patent application, No. 202011541542.1, entitled “Quantum Entangled State Processing Method and Apparatus, Device, Storage Medium, and Product”, filed with the Chinese Patent Office on Dec. 23, 2020, which is hereby incorporated by reference in its entirety.

### TECHNICAL FIELD

The present disclosure relates to a technical field of data processing, in particular, to a field of quantum calculation.

### BACKGROUND

Quantum entanglement is one of the most important resources in quantum science and technology. Quantum entanglement is the basic constituent part of the quantum calculation and quantum information processing. It plays a critical role in scenarios, such as quantum secure communication and distributed quantum calculation.

### SUMMARY

The present disclosure provides a quantum entangled state processing method and apparatus, a device, and a storage medium.

According to one aspect of the present disclosure, it is provided a quantum entangled state processing method, including:

determining n initial quantum states to be processed, wherein each initial quantum state is at least an entangled quantum state formed by at least one first qubit in a first group of qubits and at least one second qubit in a second group of qubits;

determining at least two nodes associated with the initial quantum state, wherein the first qubit is positioned at a first node of the at least two nodes, and the second qubit is positioned at a second node of the at least two nodes;

acquiring at least one first parameterized quantum circuit required by the first node and at least one second parameterized quantum circuit required by the second node matched with a preset processing scenario;

controlling, based on an initial quantum operation strategy, the first node to perform a local quantum operation on at least a portion of the first qubit in the first group of qubits by using the at least one first parameterized quantum circuit, to obtain a first measurement result, wherein the first measurement result characterizes state information of at least a portion of the first qubit after the local quantum operation via the first node;

controlling, based on the initial quantum operation strategy, the second node to perform a local quantum operation on at least a portion of the second qubit in the second group of qubits by using the at least one second parameterized quantum circuit, to obtain a second measurement result, wherein the second measurement result characterizes state information of at least a portion of the second qubit after the local quantum operation via the second node; and

obtaining an output quantum state meeting a preset requirement of the preset processing scenario at least based on the first measurement result and the second measurement result, wherein the output quantum state is an entangled quantum state formed by qubits associated with at least one initial quantum state in the n initial quantum states after the initial quantum operation strategy is executed.

According to another aspect of the present disclosure, it is provided a quantum entangled state processing apparatus, including:

an initial quantum state determination unit determining n initial quantum states to be processed, wherein each initial quantum state is at least an entangled quantum state formed by at least one first qubit in a first group of qubits and at least one second qubit in a second group of qubits;

an associated node determination unit for determining at least two nodes associated with the initial quantum state, wherein the first qubit is positioned at a first node of the at least two nodes, and the second qubit is positioned at a second node of the at least two nodes;

a parameterized quantum circuit acquisition unit for acquiring at least one first parameterized quantum circuit required by the first node and at least one second parameterized quantum circuit required by the second node matched with a preset processing scenario;

a quantum operation strategy control unit for controlling, based on an initial quantum operation strategy, the first node to perform a local quantum operation on at least a portion of the first qubit in the first group of qubits by using the at least one first parameterized quantum circuit, to obtain a first measurement result, wherein the first measurement result characterizes state information of at least a portion of the first qubit after the local quantum operation via the first node; controlling, based on the initial quantum operation strategy, the second node to perform a local quantum operation on at least a portion of the second qubit in the second group of obits by using the at least one second parameterized quantum circuit, to obtain a second measurement result, wherein the second measurement result characterizes state information of at least a portion of the second qubit after the local quantum operation via the second node; and

a result output unit for obtaining an output quantum state meeting a preset requirement of the preset processing scenario at least based on the first measurement result and the second measurement result, wherein the output quantum state is an entangled quantum state formed by qubits associated with at least one initial quantum state in the n initial quantum states after the initial quantum operation strategy is executed.

According to another aspect of the present disclosure, it is provided an electronic device, including:

at least one processor; and

a memory communicatively connected to the at least one processor, wherein

the memory stores instructions executable by the at least one processor, and the instructions, when executed by the at least one processor, enable the at least one processor to perform the method provided in any one of embodiments of the present disclosure.

According to another aspect of the present disclosure, there is provided a non-transitory computer-readable storage medium storing computer instructions, wherein the computer instructions, when executed by a computer, enable the computer to perform the method provided in any one of embodiments of the present disclosure.

According to another aspect of the present disclosure, a computer program product is provided that includes a computer program that, when executed by a processor, implements a method in any of the embodiments of the present disclosure.

it is to be understood that the content described in this section is not intended to identify the key or critical features of embodiments of the present disclosure, nor is it intended to limit the scope of the disclosure. Other features of the present disclosure will become readily apparent from the following description.

### BRIEF DESCRIPTION OF THE DRAWINGS

The accompanying drawings are included to provide a better understanding of the scheme and are not to be construed as limiting the present disclosure. In the drawings:

FIG. 1 is a schematic flowchart showing an implementation of a quantum entangled state processing method according to an embodiment of the present disclosure;

FIG. 2 is schematic diagram I illustrating a communication mode in a specific example of a quantum entangled state processing method according to an embodiment of the present disclosure;

FIG. 3 is schematic diagram II illustrating a communication mode in a specific example of a quantum entangled state processing method according to an embodiment of the present disclosure;

FIG. 4 is a schematic flowchart showing an implementation of a quantum entangled state processing method in a specific example according to an embodiment of the present disclosure;

FIG. 5 is a schematic structural diagram showing a quantum entangled state processing apparatus according to an embodiment of the present disclosure; and

FIG. 6 is a block diagram of electronic device for implementing a quantum entangled state processing method according to an embodiment of the present disclosure,

### DETAILED DESCRIPTION

The following describes exemplary embodiments of the present disclosure with reference to the accompanying drawings, which includes various details of embodiments of the present disclosure to facilitate understanding and should be considered as merely exemplary. Accordingly, one of ordinary skilled in the art appreciates that various changes and modifications can be made to the embodiments described herein without departing from the scope and spirit of the present disclosure. Similarly, descriptions of well-known functions and structures are omitted from the following description for clarity and conciseness.

In quantum technology, quantum entanglement is a key resource for implementing various quantum information technologies such as quantum secure communication, quantum calculation, quantum network, and the like. Various local operations and classical communication (LOCC) for quantum entanglement are an important constituent part of quantum information schemes such as Quantum key distribution, Quantum superdense coding, Quantum Teleportation, and the like. Therefore, if an LOCC operation scheme meeting practical requirements can be obtained and the LOCC operation scheme is suitable for a recent quantum equipment, a foundation is laid for practical quantum entanglement processing. Meanwhile, the development of quantum networks and distributed quantum calculation is greatly promoted.

On account of that, the scheme of the present disclosure provides a quantum entangled state processing method and apparatus, a device, a storage medium, and a product, so that an LOCC operation scheme realized on a recent quantum equipment can be obtained, realizing the processing of a quantum entangled state (also referred to as an entangled state for short or an entangled quantum state) with high efficiency, practicability, and universality. As used herein, high efficiency refers to the ability to efficiently complete a specified entanglement processing operation, the practicability means that the obtained LOCC scheme can be implemented on a recent quantum equipment, and the universality means that it is applicable to various application scenarios.

Firstly, basic concepts related to the scheme of the present disclosure are described as follows:

Qubits of an entangled state are usually distributed at two or more places separated by a certain distance. For example, for a quantum system composed of several qubits in an entangled state, Alice and Bob are in different laboratories. Moreover, the laboratories of the two people each has some qubits in the quantum system. Based on this, the physical operations allowed by Alice and Bob refer to a performance of local quantum operations and classical communication (local operations, and classical communication (LOCC)) on the qubits in the respective laboratories, referred to as LOCC operation for short. Here, a quantum operation refers to quantum gate and quantum measurement operations acting on qubits, and a local quantum operation indicates that Alice and Bob can only perform the above quantum operations on the qubit in their respective laboratories; classical communication is commonly applied between two people, such as Alice and Bob, who communicate quantum measurement to obtain a result via a classical communication mode (e.g., communication using a network and the like).

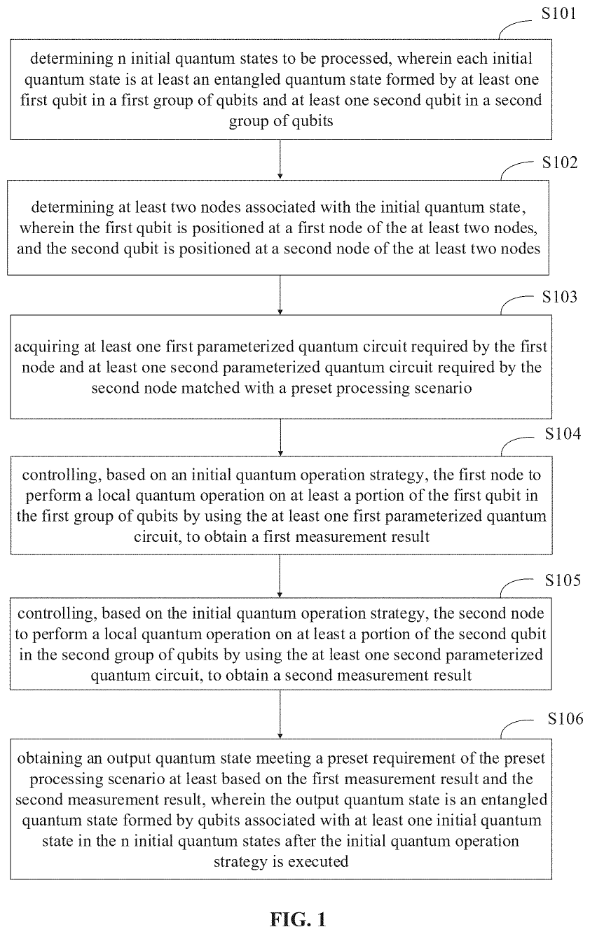

Secondly, the scheme of the present disclosure is described in detail. Specifically, FIG. 1 is a schematic flowchart showing an implementation of a quantum entangled state processing method according to an embodiment of the present disclosure. As shown in FIG. 1, the method includes following steps.

S101: determining n initial quantum states to be processed, wherein each initial quantum state is at least an entangled quantum state formed by at least one first qubit in a first group of qubits and at least one second qubit in a second group of qubits; n is a positive integer greater than or equal to 1. That is, at least one qubit per initial obit is present in the first group of qubits and the second group of qubits.

S102: determining at least two nodes associated with the initial quantum state, wherein the first qubit is positioned at a first node of the at least two nodes, and the second qubit is positioned at a second node of the at least two nodes. Here, it should be noted that the node is not a physical node, but either a virtual node in a simulation process or a logical node.

S103: acquiring at least one first parameterized quantum circuit required by the first node and at least one second parameterized quantum circuit required by the second node matched with a preset processing scenario. Here, the preset processing scenario includes, but is not limited to, at least one of the following scenarios: entanglement distillation, entanglement conversion, entanglement resolution, entanglement exchange, and the like.

Here, in the example, the first parameterized quantum circuit is a parameterized quantum circuit prepared for the first node, and the second parameterized quantum circuit is a parameterized quantum circuit prepared for the second node. The local quantum operation means that respective nodes can only perform the quantum operation and quantum measurement on the respective corresponding qubits.

S104: controlling, based on an initial quantum operation strategy, the first node to perform a local quantum operation on at least a portion of the first qubit in the first group of qubits by using the at least one first parameterized quantum circuit, to obtain a first measurement result, wherein the first measurement result characterizes state information of at least a portion of the first qubit after the local quantum operation via the first node.

S105: controlling, based on the initial quantum operation strategy, the second node to perform a local quantum operation on at least a portion of the second qubit in the second group of qubits by using the at least one second parameterized quantum circuit, to obtain a second measurement result, wherein the second measurement result characterizes state information of at least a portion of the second qubit after the local quantum operation via the second node.

It should be noted that during one local quantum operation process, each node can perform a local quantum operation only on a portion of all qubits corresponding to the node, the number or the kind of the selected qubits can be determined according to practical requirements of a practical scenario. The number and the kind of the qubits selected by different local quantum operations can be the same or different, to which the scheme of the present disclosure is not limited.

S106: obtaining an output quantum state meeting a preset requirement of the preset processing scenario at least based on the first measurement result and the second measurement result, wherein the output quantum state is an entangled quantum state formed by qubits associated with at least one initial quantum state in the n initial quantum states after the initial quantum operation strategy is executed.

That is, after an initial quantum operation strategy is executed, an entangled quantum state currently formed by a qubit associated with at least one of n parts of initial quantum states is taken as an output result. As such, the processing of an initial quantum state is completed, and the processing of a quantum entangled state is realized.

In this manner, because in the scheme of the present disclosure, a parameterized quantum circuit is adopted, the flexible and diverse structure of which makes the scheme of the present disclosure be highly expansible. For example, suitable parameterized quantum circuits can be designed for different application scenarios and quantum equipment. Moreover, an initial quantum state is not limited by the scheme of the present disclosure, so that the application range is wider, and meanwhile, the practicability and universality are strong.

In a specific example of the scheme of the present disclosure, a first group of qubits and a second group of qubits are obtained by adopting the following mode. Specifically, a qubit set associated with the initial quantum state is determined, the qubit set including at least two qubits which are mutually entangled or not; at least two obits contained in the qubit set are divided into at least two portions, and at least a first group of qubits and a second group of qubits are obtained to be distributed to at least two nodes, so that different qubits are positioned in different groups of qubits and are positioned in different nodes. That is, the first group of qubits is positioned at a first node and the second group of qubits is positioned at a second node.

Here, it is emphasized that for one initial quantum state, in a case that more than two qubits are contained in a qubit set corresponding to (i.e., associated with) the initial quantum state, it is sufficient to distribute a portion of the obits in the qubit set to the first group of qubits, and to distribute the other portion of the qubits to the second group of qubits. That is, the number of qubits owned by the first node and the second node can be the same or different, so long as the number of qubits owned by the first node and the second node is equal to the sum of the number of all qubits in the qubit set, to which the scheme of the present disclosure is not limited. Of course, the practical scenario is not limited to two nodes, and there may be multiple parties. At this time, it is sufficient to distribute the qubits in a qubit set to a plurality of different nodes, and likewise, the scheme of the present disclosure is not limited thereto.

Therefore, a foundation is laid for accurately and efficiently processing a quantum entangled state subsequently.

In a specific example of the scheme of the present disclosure, obtained output quantum states that meet a preset requirement of a preset processing scenario are in parts in total, and m is less than or equal to n. That is, in the scheme of the present disclosure, the parts of obtained output quantum states may be in, where in and ii are both positive integers greater than or equal to 1. Therefore, a foundation is laid for meeting different requirements of different scenarios. Of course, in a particular scenario, m is equal to 0, that is, no quantum state is output. For example, for an entangled resolution scenario, it is not necessary to obtain an output quantum state. It is sufficient to use a first measurement result and a second measurement result to determine a target state to which an initial quantum state belongs.

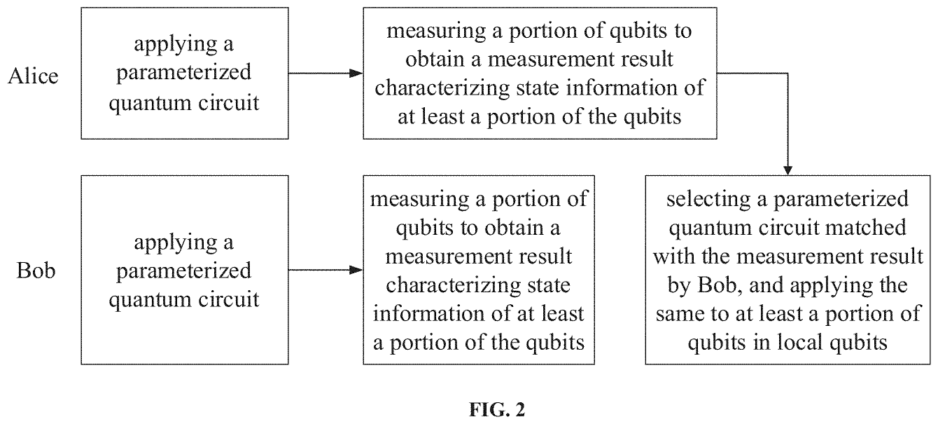

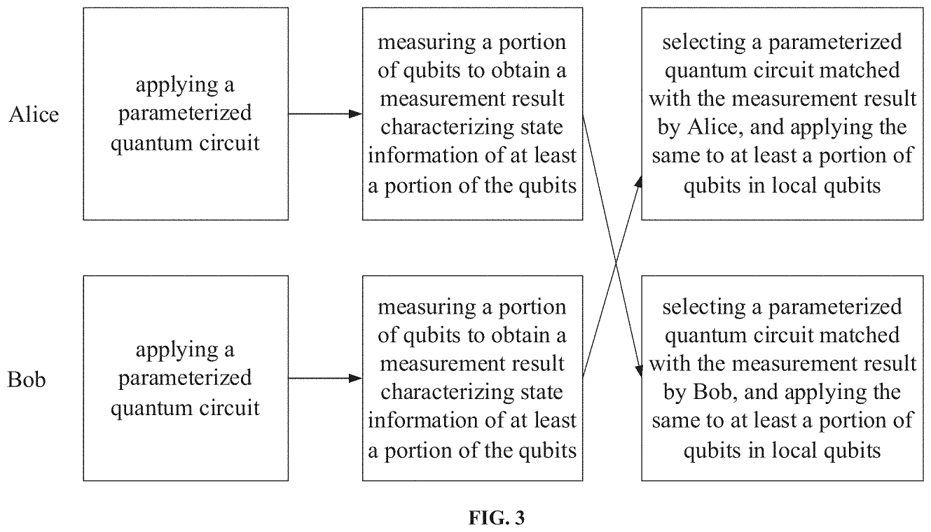

In a specific example of the scheme of the present application, the initial quantum operation strategy further indicates a communication mode between different nodes, to facilitate a transmission of the first measurement result and/or the second measurement result between at least the first node and the second node based on the communication mode. For example, as shown in FIG. 2, Alice and Bob correspond to a first node and a second node, respectively. After Alice and Bob complete a local quantum operation to obtain a measurement result characterizing state information of at least a portion of obits, one party sends the measurement result to the other party, for example, Alice (i.e., party A) sends the measurement result to the other party Bob (i.e., party B). This applies to situations where one party's communication equipment cannot send but only receive information. Alternatively, as shown in FIG. 3, both Alice and Bob send measurement results to the other party, after completing local quantum operations to obtain the measurement results characterizing state information of at least a portion of qubits. Therefore, the flexibility of the scheme of the present disclosure is improved, and a foundation is laid for meeting different requirements of different scenarios.

In a specific example of the scheme of the present disclosure, the initial quantum operation strategy further indicates a preset number of communication rounds, to complete he preset number of communication rounds of transmission of measurement results between at least the first node and the second node. Therefore, a foundation is laid for meeting different requirements of different scenarios. Meanwhile, a foundation is also laid for the efficient and accurate processing of a quantum entangled state.

In a specific example of a scheme of the present disclosure, after an information exchange, following operations can be performed at a first node and a second node. Specifically,

controlling the first node to select, from the at least one first parameterized quantum circuit corresponding to the first node, a first parameterized quantum circuit matched with a received second measurement result and the first measurement result obtained at the first node, to complete a local quantum operation again for updating the first measurement result, thereby completing one round of communication; and/or,

controlling the second node to select, from the at least one second parameterized quantum circuit corresponding to the second node, a second parameterized quantum circuit matched with a received first measurement result and the second measurement result obtained at the second node, to complete a local quantum operation again for updating the second measurement result, thereby completing one round of communication.

It should be noted in a case that a unidirectional communication is adopted, one round of communication can be completed by executing a corresponding one in the above process. In a case that a bidirectional communication is adopted, both two steps need to be executed, so that one round of communication is completed.

For example, as shown in FIG. 2 referring to a round of unidirectional communication, after Alice and Bob complete local quantum operations to obtain measurement results characterizing state information of at least a portion of qubits, one party sends the measurement result to the other party, for example, Alice (i.e., party A) sends the measurement result to the other party Bob (i.e., party B). After that, the receiving party selects, based on a received measurement result, a parameterized quantum circuit matched with the received measurement result and the measurement result of the party itself, and makes it act on the at least a portion of the qubits in the local qubits to complete the local quantum operation, so that one round of communication is completed. This applies to scenarios where the communication equipment of one party cannot send but only receive information.

Alternatively, as shown in FIG. 3 referring to a round of bidirectional communication, after Alice and Bob complete local quantum operations to obtain measurement results characterizing state information of at least a portion of qubits, both parties send the measurement results to the other party. After that, the other party re-selects parameterized quantum circuit based on a received measurement result and the measurement result of itself, and makes it act on the at least a portion of the qubits in the local qubits to complete the local quantum operation, so that one round of communication is completed. This applies to scenarios where communication equipment of both parties is functioning properly.

Furthermore, in practical application, N can also be a positive integer greater than or equal to 1. In this case, N-1 times of the above-described communication are repeated to complete N rounds of communication. Of course, the specific number of communication rounds N may be defined according to practical requirements of practical scenarios.

Therefore, the application range of the scheme of the present disclosure is improved, a foundation is laid for meeting different requirements of different scenarios. Meanwhile, a foundation is also laid for the efficient and accurate processing of a quantum entangled state.

In a specific example of the scheme of the application, a target quantum state can also be obtained, and in turns, a loss function is determined at least based on the difference between the output quantum state and the target quantum state; parameters of the first parameterized quantum circuit used by the first node and parameters of a second parameterized quantum circuit used by the second node are adjusted to minimize the loss function, so that the difference between the output quantum state and the target quantum state is adjusted, and the difference meets a preset rule. Therefore, a foundation is laid for accurately and efficiently processing the quantum entangled state subsequently.

In a specific example of the scheme of the present disclosure, the initial quantum operation strategy can also be updated to obtain a target quantum operation strategy based on a parameter of a first parameterized quantum circuit used by a first node and a parameter of a second parameterized quantum circuit used by a second node obtained after the loss function is minimized The processing of an entangled quantum state meeting the preset requirement of the preset processing scenario can be realized by using the target quantum operation strategy. Therefore, a parameter in the parameterized quantum circuit is determined through a machine learning method, such that specific modes of local quantum operation required by participating in a node are clear, and the processing of quantum entangled state is accurately and efficiently realized. Moreover, compared with the existing schemes, the scheme of the present disclosure has a wider application range and better effect.

In this way, since the scheme of the present disclosure adopts a parameterized quantum circuit, the flexible and diverse structure makes the scheme of the present disclosure highly expansible. For example, suitable parameterized quantum circuits can be selected for different application scenarios and quantum equipment. Moreover, the initial quantum state is not limited by the scheme of the present disclosure, so that the application range is wider, and meanwhile, the practicability and universality are strong.

The scheme of the present disclosure is described in further detail below with reference to examples, which are specifically as follows.

According to the scheme of the present disclosure, a LOCC operation scheme for obtaining various entangled state processing based on a quantum neural network (or parameterized quantum circuits) method is creatively designed. The LOCC operation scheme can be used for any application scenario, such as entanglement distillation, entanglement conversion, entanglement resolution, entanglement exchange, and the like, so that the limitation of the existing schemes is overcome, and the purpose of using recent quantum equipment to execute LOCC operation to process any entangled state correspondingly is achieved. Moreover, the scheme of the present disclosure has strong expandability and higher accuracy, and meanwhile, high efficiency, practicability, and universality.

The parameterized quantum circuit U(θ) in the example is generally composed of several single-qubit rotating gates and a CNOT (Controlled NOT) gate, wherein the several rotating angles compose a vector θ, serving as an adjustable parameter in the parameterized quantum circuit. More generally, the parameterized quantum circuit may be composed of several quantum circuits with an adjustable parameter. Based on this, Alice and Bob compose one LOCC operation scheme by using their own parameterized quantum circuits and combining with the local quantum operation and classical communication to process any entangled state correspondingly.

In order to determine the LOCC operation scheme, participating nodes, such as Alice and Bob, need to agree on selecting a usage scenario (i.e., processing scenario) that needs to be designed, such as entanglement distillation, entanglement conversion, entanglement resolution, entanglement exchange, etc. At the same time, it is also necessary to define n parts of initial quantum states shared by both parties, {ρ_{AB}¹, ρ_{AB}², . . . , ρ_{AB}ⁿ}, and the quantum system corresponding to each initial quantum state contains at least two qubits that are mutually entangled or not. The scheme of the present disclosure is referred to as a qubit set for short. For convenience of description, two qubits mutually entangled contained in a qubit set are introduced as an example. Certainly, in practice, the quantum system corresponding to the initial quantum state may also contain more than two qubits in an entangled state (or not entangled, or partially entangled), i.e., the qubit set may also contain more than two qubits.

Here, it needs to be emphasized that for one initial quantum state, when more than two qubits are contained in a qubit set corresponding to the initial quantum state, only a portion of the qubits in the qubit set needs to be distributed to Alice, and the other portion of the qubits needs to be distributed to Bob. That is, the number of qubits owned by Alice's lab and owned by Bob's lab can be the same or different, so long as the number of qubits owned by Alice's lab and owned by Bob's lab is equal to the sum of the number of all qubits in the qubit set, and the scheme of the present disclosure is not limited thereto. Certainly, in a practical scenario, it is not limited to two nodes of Alice and Bob, and multiple parties are also possible. At the moment, only qubits in a qubit set need to be distributed to multiple different nodes, and likewise, the scheme of the present disclosure is not limited thereto.

Based on this, Alice and Bob share n qubit sets, and two qubits in each obit set are respectively positioned in laboratories respectively corresponding to Alice and Bob, i.e., the two qubits in the qubit set are positioned in different laboratories, the laboratories of Alice and Bob each share one of them, and the laboratories of Alice and Bob each have n qubits in the n qubit sets respectively.

Here, these initial quantum states can be prepared by a third party and sent to two parties for required use, such as both parties of Alice and Bob, or these initial quantum states can be originally stored by both parties of Alice and Bob. In order to facilitate designing the scheme, it can also be assumed that the n parts of initial quantum states are all the same, that is, ρ_{AB}¹=ρ_{AB}²= . . . =ρ_{AB}ⁿ. Of course, in practical application, the n parts of initial quantum states may or may not be the same, or parts thereof may be the same and parts thereof may not be the same, and the scheme of the present disclosure is not limited thereto, Finally, the output target needs to be clear. For example, in an entanglement distillation scenario, both parties need to define the output target quantum state σ_{AB} and the number of parts m of the target quantum state to be output, where m is less than or equal to n, and both m and n are positive integers greater than or equal to 1. Certainly, in a particular scenario, in is equal to 0, i.e., no quantum state is output. For example, for an entangled resolution scenario, the output quantum state need not be obtained, and only the first measurement result and the second measurement result need to be used to determine the target state, to which the initial quantum state belongs.

After the above information is clear, a specific scheme can be designed. Specifically, Alice and Bob need to prepare the parameterized quantum circuits needed for their respective local quantum operations. In the quantum operation process, Alice and Bob can communicate the measurement results of the local quantum operation through classical communication, and then decide a subsequent local quantum operation based on a learned measurement result of the other party and a measurement result of its own. Here, the mode and times (i.e., number of rounds) N of classical communication can be decided by a specific application scenario and an experimental equipment. After all of the LOCC operations are completed, one output state ρ′_{AB} can be obtained, and a measurement result determined by a local quantum operation can be obtained. Therefore, a loss function L can be calculated from existing information and from a current application scenario. Finally, the parameter optimization method in machine learning is used to adjust the parameter in the parameterized quantum circuit to minimize the loss function L. After the loss function is minimized, such as convergence, the LOCC operation represented by the parameterized quantum circuit at this time is the LOCC operation scheme that Alice and Bob can use to experiment the entanglement processing of the initial quantum state.

It should be noted that whether a loss function is calculated, and the expression of the loss function, can be determined based on specific requirements of a practical processing scenario.

A general construction scheme for obtaining a LOCC operation scheme based on a parameterized quantum circuit is provided as follows.

Here, it should be noted that not assuming any usage scenario firstly, however, only a general construction mode is given to obtain the LOCC operation scheme. In the follow-up, cases for specific usage scenarios in the form of specific examples will be introduced. For ease of discussion, it is assumed that only two nodes (i.e., the users, Alice and Bob) participate in the entire process. Of course, multi-party users (i.e., multiple nodes) may also be involved in a practical usage scenario, and the scheme of the present disclosure can be easily expanded to multi-party users. The scheme of the present disclosure is not limited thereto. Furthermore, n parts of initial quantum states are shared by two nodes, and two qubits are contained in a qubit set corresponding to each part of the initial quantum state. Based on this, each node has a total of n qubits. Here, for ease of description, the qubit in Alice's laboratory is denoted as: qubit Aᵢ, i=1,2, . . . , n; the qubit in Bob's laboratory is denoted as: qubit Bᵢ, i=1,2, . . . , n, where Aᵢ and Bᵢ are mutually entangled and belong to a same quantum system.

Further, Alice and Bob both configure several parameterized quantum circuits with adjustable parameters, such as the parameterized quantum circuit U(θ) described above and perform the following operations in the mode and times of the classical communications between Alice and Bob.

One round of communication: after two parties complete a local quantum operation respectively, they communicate to inform the other party of the measurement result. Specifically, Alice applies the prepared parameterized quantum circuit U_{A}(α) to the qubit Aᵢ corresponding to Alice, and performs local quantum measurement on a portion of qubits in the qubit Aᵢ after the parameterized quantum circuit is applied to obtain a measurement result A. By the same reasoning, Bob applies the prepared parameterized quantum circuit U_{B}(β) to the qubit Bᵢ corresponding to Bob, and performs local quantum measurement on a portion of qubits in the qubit Bᵢ after the parameterized quantum circuit is applied to obtain a measurement result B. Communication is performed to inform the other party of the measurement result, so that the other party selects a new parameterized quantum circuit matched with the measurement result based on the learned measurement result, and the local quantum operation is performed again. Therefore, one round of communication is completed, i.e. the number of communication rounds N=1. Here, one round of communication can be divided into unidirectional communication and bidirectional communication based on communication mode, specifically as follows.

One round of unidirectional communication, as shown in FIG. 2, where after Alice and Bob complete local quantum operations to obtain measurement results characterizing the state information of at least a portion of qubits, one party sends the measurement result to the other party, for example, Alice (i.e., party A) sends a measurement result to the other party Bob (i.e., party B), then the receiving party, based on the received measurement result, selects a parameterized quantum circuit matched with the received measurement result and the measurement result of the party, and makes it act on the at least a portion of the qubits in the local qubits to complete the local quantum operation. This applies to scenarios where the communication equipment of one party cannot send information but only receive information.

One round of bidirectional communication, as shown in FIG. 3, where after Alice and Bob complete local quantum operations to obtain measurement results characterizing the state information of at least a portion of qubits, both parties send the measurement results to the other party, then the other party, based on the received measurement result and the measurement result of its own, re-selects a parameterized quantum circuit, and then makes it act on the at least a portion of the qubits in the local qubits to complete the local quantum operation. This applies to scenarios where the communication equipment of both parties is functioning properly.

Furthermore, in practical applications, N can also be a positive integer greater than or equal to 2, and at the moment, N−1 times of the above-described communication are repeated to complete N rounds of communication. Of course, the specific number of communication rounds N may be defined according to practical requirements of practical scenarios.

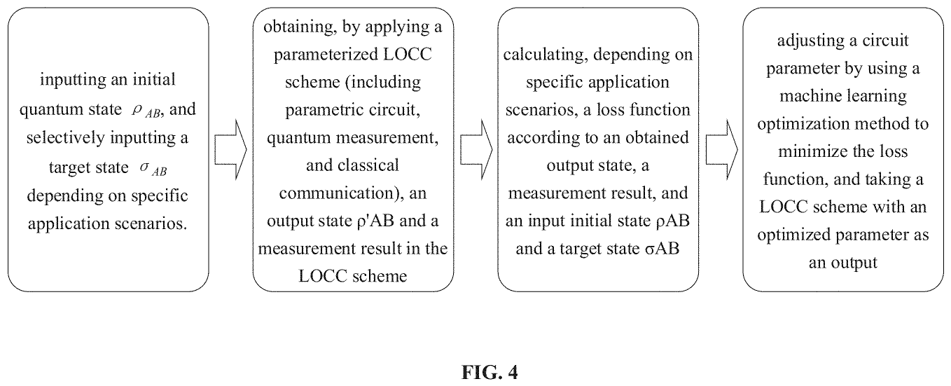

As shown in FIG. 4, specific steps include the following.

Step 1: n parts of initial quantum states ρ_{AB} are determined, and a processing scenario such as one of entanglement distillation, entanglement conversion, entanglement resolution, entanglement exchange, and the like is selected to construct a. parameterized quantum circuit matched with the processing scenario. Here, a parameterized quantum circuit can be constructed according to a specific processing scenario and a practical quantum equipment, and the parameter of the constructed parameterized quantum circuit is initialized. At the same time, an initial LOCC operation scheme (and pre-evaluation quantum operation strategy) is constructed. Here, the initial LOCC operation scheme constructed contains a local quantum operation, and respective selected parameterized quantum circuits.

Step 2: n parts of initial quantum states ρ_{AB} are used as inputs and run on a constructed preset LOCC operation scheme to obtain an output quantum state p′_{AB}. Here, the output quantum state ρ′_{AB} may be one part or m parts, and the scheme of the present disclosure is not limited thereto. Further, an obtained output quantum state ρ′_{AB} is a quantum entangled state corresponding to at least one first target qubit selected from the qubit Aᵢ and at least one second target obit selected from the qubit Bᵢ.

Here, for different application scenarios, after an output quantum state and a measurement result are obtained, the processing of the quantum entangled state can be completed. Certainly, a subsequent processing may also be performed based on the obtained output quantum state to complete quantum entanglement processing in a particular scenario.

Step 3: depending on a specific application scenario, a loss function Lin the application scenario is calculated based on the obtained output quantum state ρ′_{AB}, the measurement result and the target quantum state σ_{AB}, Here, the loss function can measure and learn the merits and demerits of the scheme from a certain angle, and the specific expression can be set based on different application scenarios.

Step 4: the parameter in the parameterized quantum circuit is adjusted by a gradient descent method or other optimization methods, and the above steps are repeated to minimize the loss function L.

Step 5: after the loss function L is minimized, the optimization of the parameter in the parameterized quantum circuit is completed. The entire design scheme is output, where the output information includes: the characteristics of the scheme (e.g., single-round unidirectional/single-round bidirectional, and like communication mode), the number of communication rounds, the parameterized quantum circuit required to be prepared by each node (i.e., each party) such as Alice and Bob, the local quantum operation required to be performed, and the parameter of the parameterized quantum circuit obtained from the final learning process. And then the initial LOCC operation scheme is updated to obtain a target LOCC operation scheme. The target LOCC operation scheme includes the above-described output information. In this way, the processing of the quantum entangled. state is realized.

The scheme of the present disclosure is described in further detail below with reference to specific scenarios as follows.

Scenario One: taking an entanglement purification (i.e., entangled distillation) scenario as an example, specifically, Alice and Bob share n parts of initial quantum states ρ_{AB}, and it is intended to purify it into the target Bell state Φ⁺ (Bell state) (one of the four Bell states). At this time, after the initial LOCC operation of the scheme of the present disclosure is adopted, an output quantum state ρ′_{AB} is obtained, and the fidelity between the output quantum state ρ′_{AB} and the target Bell state Φ⁺ is denoted as Tr(Φ⁺ρ′_{AB}), where Tr(A) represents the trace of matrix A, i.e. the sum of the elements on the diagonal. In practical applications, the higher the fidelity, the better it is. Because the higher the fidelity, the closer it is to the target Bell state, such that the fidelity here can be understood as the degree of similarity between the two states. In this case, a loss function L=1−Tr(Φ⁺ρ′_{AB}) is defined, and by adjusting the parameter of the parameterized quantum circuit used in the initial LOCC operation scheme, the loss function L is minimized. An obtained output quantum state after the minimization can be referred to as the target output quantum state, i.e., approximately equal to the target Bell state Φ⁺, so that the entanglement purification of the initial quantum state ρ_{AB} is realized, and a purifying is performed to obtain the approximate target Bell state Φ⁺. Here, the fidelity between the target output quantum state obtained after the minimization of the loss function L and the target Bell state Φ⁺ is higher than that of the initial quantum state ρ_{AB}.

Scenario Two: taking entanglement dilution or Bell-state-based target state scenario preparation as an example. Specifically, Alice and Bob share n parts of the initial Bell state and want to dilute them into a target state ρ_{AB}. The application scenario of the task is to prepare the quantum entangled state required by the target distributed quantum calculation task through the shared initial Bell state.

At this time, after the initial LOCC operation of the scheme of the present disclosure is adopted, an output quantum state ρ′_{AB} is obtained. The fidelity between the output quantum state ρ′_{AB} and the target state ρ_{AB} is denoted as F (ρ′_{AB}, ρ_{AB}), where F represents the fidelity of the two quantum states. In practical applications, the higher the fidelity, the better it is. Because the higher the fidelity represents the closer an obtained output quantum state is to a target state, where the fidelity can be understood as the degree of similarity between two states. In this case, the loss function is defined as L=1−F(ρ′_{AB}, ρ_{AB}). The loss function L is minimized by adjusting the parameter of the parameterized quantum circuit used in the initial LOCC operation scheme, so that an obtained output quantum state ρ′_{AB} is as close as possible to the target state ρ_{AB}, and the purpose of preparing an entangled state is achieved. This process is also called entanglement dilution because it consumes a standard entangled state, i.e., the Bell state. Here, by minimizing the loss function L, a state in which the Bell state is diluted into the approximate target state ρ_{AB} can be obtained, and the fidelity between the obtained target output quantum state and the target quantum state ρ_{AB} is high.

Here, it needs to be noted that after the minimization of the loss function, the initial LOCC operation scheme can be updated based on the parameter optimized by minimizing the loss function and the used parameterized quantum circuit to further obtain the target LOCC operation scheme. In a case that the target LOCC operation scheme is applied to a quantum equipment, the processing of the quantum entangled state for a particular application scenario can be completed.

In this way, since the scheme of the present disclosure adopts a parameterized quantum circuit, the flexible and diverse structure makes the scheme of the present disclosure highly expansible. When the parameterized quantum circuit is depicted, multiple schemes can be selected to cope with different circumstances.

1. The use of a parameterized quantum circuit can be easily extended to n parts of initial quantum states.

2. One-direction communication mode can be flexibly used, that is, Alice informs Bob of a measurement result without Bob informing Alice of its own result, or a two-direction communication protocol, that is, Alice and Bob inform each other of their measurement results, so that a parameterized quantum circuit is selected.

3. The parameterized quantum circuit may also be selected based on a required number of communication rounds, N.

4. The present example scheme applies to n->1, i,e., the input. initial quantum state has n parts from one of which the quantum state is output. Of course, it is also possible to apply n->m, i.e. there are n parts of the input initial quantum state, resulting in m output quantum states. Here, the n quantum states of the input initial quantum state may also be different, and the parameterized quantum circuit is selected based on this requirement,

In summary, the scheme of the present disclosure uses a parameterized quantum circuit, determines parameters in the parameterized quantum circuit through a machine learning method, so that a specific mode of a local quantum operation required by a node participating in is determined. Further, there exists no limitation on an initial quantum state. As a result, the application range is wider compared with the existing schemes. Moreover, the target LOCC scheme obtained through machine learning optimization can often obtain better effect under the corresponding application scenarios, so that it has high efficiency.

Furthermore, due to the adoption of a parameterized quantum circuit in the scheme of the present disclosure, the flexible and diverse structure makes the scheme of the present application highly expansible and applicable, making it possible to be designed for various application scenarios and quantum equipment. For example, the scheme of the present disclosure can be applied to various application scenarios, including but not limited to entanglement distillation, entanglement conversion, entanglement resolution, and entanglement exchange, and the practicability and universality are high.

Here, it needs to be noted that the above-described scheme can be simulated on a classical equipment, such as a classical computer, and after the above-described target LOCC operation scheme is obtained by a classical computer simulation, a practical operation can be performed on quantum equipment, so that the processing of a quantum entangled state can be realized.

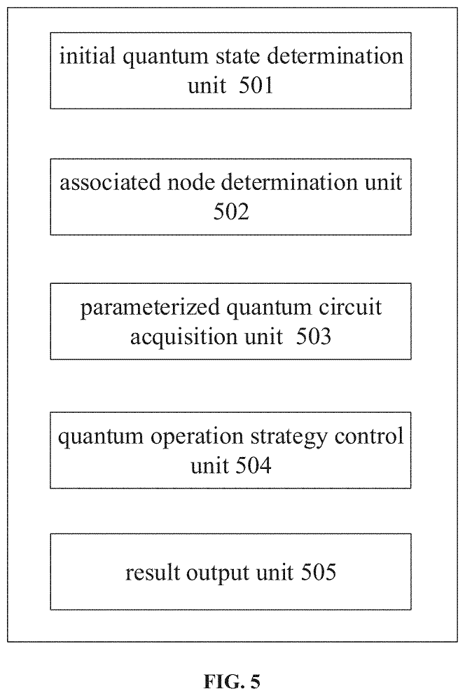

According to the scheme of the present disclosure, it is further provided a quantum entangled state processing apparatus. As shown in FIG. 5, the apparatus includes:

an initial quantum state determination unit 501 for determining n initial quantum states to be processed, wherein each initial quantum state is at least an entangled quantum state formed by at least one first qubit in a first group of qubits and at least one second qubit in a second group of qubits;

an associated node determination unit 502 for determining at least two nodes associated with the initial quantum state, wherein the first qubit is positioned at a first node of the at least two nodes, and the second qubit is positioned at a second node of the at least two nodes;

a parameterized quantum circuit acquisition unit 503 for acquiring at least one first parameterized quantum circuit required by the first node and at least one second parameterized quantum circuit required by the second node matched with a preset processing scenario;

a quantum operation strategy control unit 504 for controlling, based on an initial quantum operation strategy, the first node to perform a local quantum operation on at least a portion of the first qubit in the first group of qubits by using the at least one first parameterized quantum circuit, to obtain a first measurement result, wherein the first measurement result characterizes state information of at least a portion of the first qubit after the local quantum operation via the first node; controlling, based on the initial quantum operation strategy, the second node to perform a local quantum operation on at least a portion of the second qubit in the second group of qubits by using the at least one second parameterized quantum circuit, to obtain a second measurement result, wherein the second measurement result characterizes state information of at least a portion of the second qubit after the local quantum operation via the second node; and

a result output unit 505 for obtaining an output quantum state meeting a preset requirement of the preset processing scenario at least based on the first measurement result and the second measurement result, wherein the output quantum state is an entangled quantum state formed by qubits associated with at least one initial quantum state in the n initial quantum states after the initial quantum operation strategy is executed.

In a specific example of the scheme of the present disclosure, the apparatus further includes: a distribution unit for determining a qubit set associated with the initial quantum state, wherein the qubit set contains at least two qubits which are mutually entangled or not mutually entangled; and dividing at least two qubits contained in the qubit set into at least two portions, and obtaining at least a first group of qubits and a second group of qubits, to distribute to at least two nodes, so that different qubits are positioned in different groups of qubits and at different nodes.

In a specific example of the scheme of the present disclosure, a total of m output quantum states that meet the preset requirement of the preset processing scenario are obtained, wherein m is less than or equal to n.

In a specific example of the scheme of the present disclosure, the initial quantum operation strategy further indicates a communication mode between different nodes, to facilitate a transmission of the first measurement result and/or the second measurement result between at least the first node and the second node based on the communication mode.

In a specific example of the scheme of the present disclosure, the initial quantum operation strategy further indicates a preset number of communication rounds, to complete the preset number of communication rounds of transmissions of measurement results between at least the first node and the second node.

In a specific example of the scheme of the present disclosure, the quantum operation strategy control unit is further used for:

controlling the first node to select, from the at least one first parameterized quantum circuit corresponding to the first node, a first parameterized quantum circuit matched with a received second measurement result and the first measurement result obtained at the first node, to complete a local quantum operation again for updating the first measurement result; and/or

controlling the second node to select, from the at least one second parameterized quantum circuit corresponding to the second node, a second parameterized quantum circuit matched with a received first measurement result and the second measurement result obtained at the second node, to complete a local quantum operation again for updating the second measurement result.

In a specific example of the scheme of the present disclosure, the apparatus further includes:

a target determination unit for acquiring a target quantum state; and

an optimization unit for determining a loss function based on at least a difference between the output quantum state and the target quantum state; and adjusting the difference between the output quantum state and the target quantum state by adjusting a parameter of the first parameterized quantum circuit used by the first node and a parameter of the second parameterized quantum circuit used by the second node to minimize the loss function, so that the difference meets a preset rule.

In a specific example of the scheme of the present disclosure, the result output unit is further used for updating the initial quantum operation strategy to obtain a target quantum operation strategy based on the parameter of the first parameterized quantum circuit used by the first node and the parameter of the second parameterized quantum circuit used by the second node obtained after the loss function is minimized, wherein processing of an entangled quantum state meeting the preset requirement of the preset processing scenario can be realized by using the target quantum operation strategy.

The functions of respective units of the quantum entangled state processing apparatus of embodiments of the present disclosure can be referred to corresponding descriptions of the above-described method, which will not be repeated in detail here.

Here, it should be noted that the quantum entangled state processing apparatus described in the scheme of the present disclosure may be classical equipment, such as a classical computer, classical electronic equipment, etc., in which case the above-mentioned units may be implemented by the hardware of the classical equipment, such as a memory, a processor, etc. As a matter of course, the entangled quantum state processing apparatus disclosed in the scheme of the present disclosure can also be quantum equipment, in which case the respective units above-mentioned can be realized through quantum hardware and the like.

According to an embodiment of the present disclosure, the present disclosure also provides an electronic device, a readable storage medium, and a computer program product.

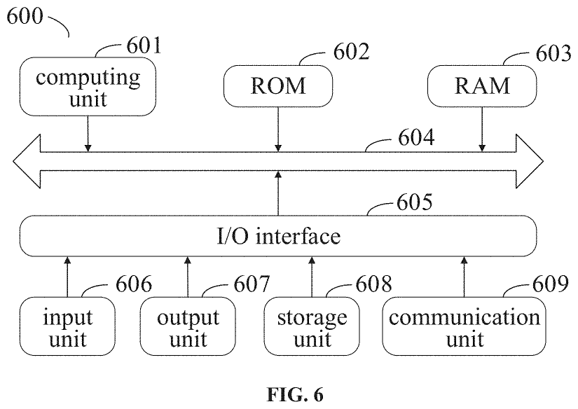

FIG. 6 illustrates a schematic block diagram of an exemplary electronic device 600 that may be used to implement an embodiment of the present disclosure. The electronic device is intended to represent various forms of digital computers, such as laptop computers, desktop computers, workbenches, personal digital assistants, servers, blade servers, mainframe computers, and other suitable computers. Electronic apparatuses may also represent various forms of mobile devices, such as personal digital assistants, cellular phones, smart phones, wearable devices, and other similar computing devices. The components shown herein, their connections and relationships, and their functions are merely examples, and are not intended to limit the implementation of the present disclosure described and/or claimed herein.

As shown in FIG. 6, the apparatus 600 includes a computing unit 601 that may perform various suitable actions and processes in accordance with a computer program stored in a read only memory (ROM) 602 or a computer program loaded from a storage unit 608 into a random-access memory (RAM) 603. In the RAM 603, various programs and data required for the operation of the storage apparatus 600 can also be stored. The computing unit 601, the ROM 602 and the RAM 603 are connected to each other through a bus 604. An input/output (I/O) interface 605 is also connected to the bus 604.

A number of components in the apparatus 600 are connected to the I/O interface 605, including an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the apparatus 600 to exchange information/data with other apparatuses over a computer network, such as the Internet, and/or various telecommunication networks.

The computing unit 601 may be various general purpose and/or special purpose processing components having processing and computing capabilities. Some examples of the computing unit 601 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 601 performs various methods and processes described above, such as a quantum entangled state processing method. For example, in some embodiments, the quantum entangled state processing method may be implemented as a computer software program tangibly contained in a machine-readable medium, such as the storage unit 808. In some embodiments, some or all of computer programs may be loaded into and/or installed on the apparatus 600 via a ROM 602 and/or a communication unit 609. When a computer program is loaded into the RAM 603 and executed by the computing unit 601, one or more steps of the quantum entangled state processing method described above may be performed. Alternatively, in other embodiments, the computing unit 601 may be configured to perform the quantum entangled state processing method by any other suitable means (e.g., via a firmware).

Various implementation modes of the system and technology described. above herein may be implemented in a digital electronic circuit system, an integrated circuit system, a field programmable gate array (FPGA), an application specific integrated circuit (ARC), an application specific standard product (ASSP), a system on chip system (SOC), a load programmable logic device (CPLD), computer hardware, firmware, software, and/or a combination thereof. These various implementation modes may include: implementing in one or more computer programs, which can be executed and/or interpreted on a programmable system including at least one programmable processor. The programmable processor can be a dedicated or general-purpose programmable processor, which can receive data and instructions from, and transmit the data and instructions to, a memory system, at least one input device, and at least one output device.

Program codes for implementing methods of the present disclosure may be written in any combination of one or more programming languages. These program codes may be provided to a processor or a controller of a general-purpose computer, a special purpose computer, or other programmable data processing units, such that program codes, when executed by the processor or the controller, cause functions/operations specified in a flowchart and/or a block diagram to be performed. The program codes may be executed entirely on a machine, partly on a machine, partly on a machine as a stand-alone software package and partly on a remote machine, or entirely on a remote machine or a server.

In the context of the present disclosure, a machine-readable medium can be a tangible medium that may contain or store a program for use by or in connection with an instruction execution system, device, or apparatus. The machine-readable medium may be a machine-readable signal medium or a machine-readable storage medium. The machine-readable medium may include, but is not limited to, electronic, magnetic, optical, electromagnetic, infrared, or semi-conductive systems, devices, or apparatuses, or any suitable combination thereof More specific examples of the machine-readable storage medium may include one or more wire-based electrical connections, a portable computer diskette, a hard disk, a random-access memory (RAM), a read-only memory (ROM), an erasable programmable read-only memory (EPROM or Flash memory), an optical fiber, a portable compact disk read-only memory (CD-ROM), an optical storage apparatus, a magnetic storage apparatus, or any suitable combination thereof.

In order to provide interactions with a user, the system and technology described herein may be implemented on a computer having a display device (for example, a cathode ray tube (CRT) or a liquid crystal display (LCD) monitor) for displaying information to the user; and a keyboard and pointing device (e.g., a mouse or a trackball) through which a user can provide input to the computer. Other types of devices may also be used to provide an interaction with a user. For example, the feedback provided to a user may be any form of sensory feedback (e.g., visual feedback, auditory feedback, or tactile feedback); and the inputs from a user may be received in any form, including acoustic input, voice input, or tactile input.

The systems and techniques described herein may be implemented in a computing system (for example, as a data server) that includes back-end components, or be implemented in a computing system (for example, an application server) that includes middleware components, or be implemented in a computing system (for example, a user computer with a graphical user interface or a web browser through which the user may interact with the implementation of the systems and technologies described herein) that includes front-end components, or be implemented in a computing system that includes any combination of such back-end components, intermediate components, or front-end components. The components of the system may be interconnected by any form or medium of digital data communication (for example, a communication network), Examples of communication networks include: a Local Area Network (LAN), a Wide Area Network (WAN), the Internet.

The computer system may include a client and a server. The client and the server are generally remote from each other and typically interact through a communication network. The client-server relationship is generated by computer programs that run on respective computers and have a client-server relationship with each other.

It should be understood that various forms of processes shown above may be used to reorder, add, or delete steps. For example, respective steps described in the present disclosure may be executed in parallel, or may be executed sequentially, or may be executed in a different order, as long as the desired result of the technical solution disclosed in the present disclosure can be achieved, to which no limitation is made herein.

The above specific embodiments do not constitute a limitation on the protection scope of the present disclosure. It should be understood by those skilled in the art that various modifications, combinations, sub-combinations, and substitutions may be made according to design requirements and other factors. Any modification, equivalent replacement and improvement, and the like made within the spirit and principle of the present disclosure shall be fall in the protection scope of the present disclosure.

What is claimed is:

1. A quantum entangled state processing method, comprising:
determining n initial quantum states to be processed, wherein each initial quantum state is at least an entangled quantum state formed by at least one first qubit in a first group of qubits and at least one second qubit in a second group of qubits;
determining at least two nodes associated with the initial quantum state, wherein the first qubit is positioned at a first node of the at least two nodes, and the second qubit is positioned at a second node of the at least two nodes;
acquiring at least one first parameterized quantum circuit required by the first node and at least one second parameterized quantum circuit required by the second node matched with a preset processing scenario;
controlling, based on an initial quantum operation strategy, the first node to perform a local quantum operation on at least a portion of the first qubit in the first group of qubits by using the at least one first parameterized quantum circuit, to obtain a first measurement result, wherein the first measurement result characterizes state information of at least a portion of the first qubit after the local quantum operation via the first node;
controlling, based on the initial quantum operation strategy, the second node to perform a local quantum operation on at least a portion of the second qubit in the second group of qubits by using the at least one second parameterized quantum circuit, to obtain a second measurement result, wherein the second measurement result characterizes state information of at least a portion of the second qubit after the local quantum operation via the second node; and
obtaining an output quantum state meeting a preset requirement of the preset processing scenario at least based on the first measurement result and the second measurement result, wherein the output quantum state is an entangled quantum state formed by qubits associated with at least one initial quantum state in the n initial quantum states after the initial quantum operation strategy is executed.

2. The quantum entangled state processing method of claim 1, further comprising:
determining a qubit set associated with the initial quantum state, wherein the qubit set contains at least two qubits which are mutually entangled or not mutually entangled; and
dividing at least two qubits contained in the qubit set into at least two portions, and obtaining at least a first group of obits and a second group of qubits, to distribute to at least two nodes, so that different qubits are positioned in different groups of qubits and at different nodes,

3. The quantum entangled state processing method of claim 1, wherein a total of m output quantum states that meet the preset requirement of the preset processing scenario are obtained, wherein m is less than or equal to n.

4. The quantum entangled state processing method of claim 1, wherein the initial quantum operation strategy further indicates a communication mode between different nodes, to facilitate a transmission of the first measurement result and/or the second measurement result between at least the first node and the second node based on the communication mode.

5. The quantum entangled state processing method of claim 1, wherein the initial quantum operation strategy further indicates a preset number of communication rounds, to complete the preset number of communication rounds of transmissions of measurement results between at least the first node and the second node.

6. The quantum entangled state processing method of claim 4, further comprising:
controlling the first node to select, from the at least one first parameterized quantum circuit corresponding to the first node, a first parameterized quantum circuit matched with a received second measurement result and the first measurement result obtained at the first node, to complete a local quantum operation again for updating the first measurement result; and/or
controlling the second node to select, from the at least one second parameterized quantum circuit corresponding to the second node, a second parameterized quantum circuit matched with a received first measurement result and the second measurement result obtained at the second node, to complete a local quantum operation again for updating the second measurement result.

7. The quantum entangled state processing method of claim 5, further comprising:
controlling the first node to select, from the at least one first parameterized quantum circuit corresponding to the first node, a first parameterized quantum circuit matched with a received second measurement result and the first measurement result obtained at the first node, to complete a local quantum operation again for updating the first measurement result; and/or
controlling the second node to select, from the at least one second parameterized quantum circuit corresponding to the second node, a second parameterized quantum circuit matched with a received first measurement result and the second measurement result obtained at the second node, to complete a local quantum operation again for updating the second measurement result.

8. The quantum entangled state processing method of claim 6, further comprising:
acquiring a target quantum state;
determining a loss function based on at least a difference between the output quantum state and the target quantum state; and
adjusting the difference between the output quantum state and the target quantum state by adjusting a parameter of the first parameterized quantum circuit used by the first node and a parameter of the second parameterized quantum circuit used by the second node to minimize the loss function, so that the difference meets a preset rule.

9. The quantum entangled state processing method of claim 8, further comprising:
updating the initial quantum operation strategy to obtain a target quantum operation strategy based on the parameter of the first parameterized quantum circuit used by the first node and the parameter of the second parameterized quantum circuit used by the second node obtained after the loss function is minimized, wherein processing of an entangled quantum state meeting the preset requirement of the preset processing scenario can be realized by using the target quantum operation strategy.

10. An electronic device, comprising:
at least one processor; and
a memory communicatively connected to the at least one processor, wherein
the memory stores instructions executable by the at least one processor, and the instructions, when executed by the at least one processor, enable the at least one processor to:
determine n initial quantum states to be processed, wherein each initial quantum state is at least an entangled quantum state formed by at least one first qubit in a first group of qubits and at least one second qubit in a second group of qubits;
determine at least two nodes associated with the initial quantum state, wherein the first qubit is positioned at a first node of the at least two nodes, and the second qubit is positioned at a second node of the at least two nodes;
acquire at least one first parameterized quantum circuit required by the first node and at least one second parameterized quantum circuit required by the second node matched with a preset processing scenario;
control, based on an initial quantum operation strategy, the first node to perform a local quantum operation on at least a portion of the first qubit in the first group of qubits by using the at least one first parameterized quantum circuit, to obtain a first measurement result, wherein the first measurement result characterizes state information of at least a portion of the first qubit after the local quantum operation via the first node;
control, based on the initial quantum operation strategy, the second node to perform a local quantum operation on at least a portion of the second qubit in the second group of qubits by using the at least one second parameterized quantum circuit, to obtain a second measurement result, wherein the second measurement result characterizes state information of at least a portion of the second qubit after the local quantum operation via the second node; and
obtain an output quantum state meeting a preset requirement of the preset processing scenario at least based on the first measurement result and the second measurement result, wherein the output quantum state is an entangled quantum state formed by qubits associated with at least one initial quantum state in the ii initial quantum states after the initial quantum operation strategy is executed.

11. The electronic device according to claim 10, wherein the instructions are executed by the at least one processor to further enable the at least one processor to:
determine a qubit set associated with the initial quantum state, wherein the qubit set contains at least two qubits which are mutually entangled or not mutually entangled; and
divide at least two qubits contained in the qubit set into at least two portions, and obtain at least a first group of qubits and a second group of qubits, to distribute to at least two nodes, so that different qubits are positioned in different groups of qubits and at different nodes.

12. The electronic device according to claim 10, wherein a total of m output quantum states that meet the preset requirement of the preset processing scenario are obtained, wherein m is less than or equal to n.

13. The electronic device according to claim 11, wherein the initial quantum operation strategy further indicates a communication mode between different nodes, to facilitate a transmission of the first measurement result and/or the second measurement result between at least the first node and the second node based on the communication mode.

14. The electronic device according to claim 11, wherein the initial quantum operation strategy further indicates a preset number of communication rounds, to complete the preset number of communication rounds of transmissions of measurement results between at least the first node and the second node.

15. The electronic device according to claim 13, wherein the instructions are executed by the at least one processor to further enable the at least one processor to:
control the first node to select, from the at least one first parameterized quantum circuit corresponding to the first node, a first parameterized quantum circuit matched with a received second measurement result and the first measurement result obtained at the first node, to complete a local quantum operation again for updating the first measurement result; and/or
control the second node to select, from the at least one second parameterized quantum circuit corresponding to the second node, a second parameterized quantum circuit matched with a received first measurement result and the second measurement result obtained at the second node, to complete a local quantum operation again for updating the second measurement result.

16. The electronic device according to claim 14, wherein the instructions are executed by the at least one processor to further enable the at least one processor to:
control the first node to select, from the at least one first parameterized quantum circuit corresponding to the first node, a first parameterized quantum circuit matched with a received second measurement result and the first measurement result obtained at the first node, to complete a local quantum operation again for updating the first measurement result; and/or
control the second node to select, from the at least one second parameterized quantum circuit corresponding to the second node, a second parameterized quantum circuit matched with a received first measurement result and the second measurement result obtained at the second node, to complete a local quantum operation again for updating the second measurement result.

17. The electronic device according to claim 15, wherein the instructions are executed by the at least one processor to further enable the at least one processor to:
acquire a target quantum state;
determine a loss function based on at least a difference between the output quantum state and the target quantum state; and
adjust the difference between the output quantum state and the target quantum state by adjusting a parameter of the first parameterized quantum circuit used by the first node and a parameter of the second parameterized quantum circuit used by the second node to minimize the loss function, so that the difference meets a preset rule.

18. The electronic device according to claim 17, wherein the instructions are executed by the at least one processor to further enable the at least one processor to:
update the initial quantum operation strategy to obtain a target quantum operation strategy based on the parameter of the first parameterized quantum circuit used by the first node and the parameter of the second parameterized quantum circuit used by the second node obtained after the loss function is minimized, wherein processing of an entangled quantum state meeting the preset requirement of the preset processing scenario can be realized by using the target quantum operation strategy.

19. A non-transitory computer-readable storage medium storing computer instructions, the computer instructions, when executed by a computer, enable the computer to:
determine n initial quantum states to be processed, wherein each initial quantum state is at least an entangled quantum state formed by at least one first qubit in a first group of qubits and at least one second qubit in a second group of qubits;
determine at least two nodes associated with the initial quantum state, wherein the first qubit is positioned at a first node of the at least two nodes, and the second qubit is positioned at a second node of the at least two nodes;
acquire at least one first parameterized quantum circuit required by the first node and at least one second parameterized quantum circuit required by the second node matched with a preset processing scenario;
control, based on an initial quantum operation strategy, the first node to perform a local quantum operation on at least a portion of the first qubit in the first group of qubits by using the at least one first parameterized quantum circuit, to obtain a first measurement result, wherein the first measurement result characterizes state information of at least a portion of the first qubit after the local quantum operation via the first node;
control, based on the initial quantum operation strategy, the second node to perform a local quantum operation on at least a portion of the second qubit in the second group of qubits by using the at least one second parameterized quantum circuit, to obtain a second measurement result, wherein the second measurement result characterizes state information of at least a portion of the second qubit after the local quantum operation via the second node; and
obtain an output quantum state meeting a preset requirement of the preset processing scenario at least based on the first measurement result and the second measurement result, wherein the output quantum state is an entangled quantum state formed by qubits associated with at least one initial quantum state in the n initial quantum states after the initial quantum operation strategy is executed.

20. The non-transitory computer-readable storage medium according to claim 19, wherein the computer instructions, when executed by a computer, further cause the computer to:
determine a qubit set associated with the initial quantum state, wherein the qubit set contains at least two qubits which are mutually entangled or not mutually entangled; and
divide at least two qubits contained in the qubit set into at least two portions, and obtain at least a first group of qubits and a second group of qubits, to distribute to at least two nodes, so that different qubits are positioned in different groups of qubits and at different nodes.
